(19) United States
(12) Patent Application Publication
(10) Pub. No.: US 2015/0294008 A1
(43) Pub. Date: Oct. 15, 2015

(54) SYSTEM AND METHODS FOR PROVIDING LEARNING OPPORTUNITIES WHILE ACCESSING INFORMATION OVER A NETWORK

(71) Applicant: Lassolt, Ltd., Tel-Aviv (IL)

(72) Inventors: Jan Ihmels, Nes-Ziona (IL); Orly Fuhrman, Tel-Aviv (IL)

(73) Assignee: Lassolt, Ltd., Tel-Aviv (IL)

(21) Appl. No.: 14/527,091

(22) Filed: Oct. 29, 2014

Related U.S. Application Data
(60) Provisional application No. 61/979,005, filed on Apr. 14, 2014.

(51) Int. Cl. G06F 17/30; G09B 19/00; H04L 29/08

(52) U.S. Cl. CPC G06F 17/30867; H04L 67/02; G06F 17/3053; G09B 19/00

(57) ABSTRACT

A method for facilitating learning of unfamiliar texts appearing in content provided over a network includes parsing each content that has not yet been handled; tokenizing each parsed content into at least a unit of information; providing a first storage unit with the at least a unit of information; providing a second storage unit with at least a value for a user's familiarity with the at least a unit of information; providing the second storage unit with at least a value for a user's desire to be exposed to the at least a unit of information; determining a suitability rank for the content to at least a user based on a value in the first storage unit and respective of the user information of the at least a user in the second storage unit; and recommending one or more content items respective of the suitability rank of each content.

### CROSS-REFERENCE TO RELATED APPLICATIONS

This application claims the benefit of U.S. Provisional Application No. 61/979,005 filed on Apr. 14, 2014, the contents of which are hereby incorporated by reference.

### TECHNICAL FIELD

The present invention relates generally to learning assistance units and, more particularly, to providing content containing such learning assistance units over a network.

### BACKGROUND

The ubiquity of the Internet and, thus, access to information has exploded over the last decade. People from around the world may access information in a variety of languages at the press of a button. These people can simply operate a web browser to search for documents and receive a wealth of units of information from around the globe. In many cases, content accessed by a user may contain units of information that the user is not familiar with, such as words or terminology in a language the user does not speak fluently or understand completely, words or terminology related to subject matter which the user is not familiar with, and so on.

As a result, various references such as encyclopedias, translation utilities, and dictionary utilities have been made available either in context directly through the web browser or other source of information, or out of context by accessing, for example, on-line dictionaries. Using such on-line dictionaries, a user may now understand the word for the specific content. However, since the experience is not repeated frequently, the user knowledge ultimately decays and this learning experience may only result in the user retaining information for a short period of time. Systematic exposure to such novel units of information can ensure that newly acquired information is not lost prior to long term retention. On the other hand, efficient learning requires content that does not overwhelm the user with too many novel units of information.

As an example, a user may encounter the word “chien” in the context of an article written in the French language that he or she reads on the internet. Upon looking up the word “chien” in an on-line French-to-English dictionary, the user learns that the word “chein” is French for the word “dog.” Upon finishing the browsing session, the user may find that he or she cannot recall the word that he or she looked up. Further, upon subsequently encountering the word in another article a week later, the user must again look up the translation of the word.

Various reference guides also exist to provide users with basic understanding of terms and concepts related to various fields including, but not limited to, mathematics, science, art, literature, sports, games and hobbies, music, business, and so on. Similar to learning languages, singular exposures to new content do not guarantee long-term retention of words and concepts. As an example, a user seeking to learn more about music may look up definitions for the terms “meter” and “timbre” during his or her learning. However, a week after the learning session, the user may find that he or she no longer recalls the meanings of the terms. Upon subsequently encountering such terms, the user must again look up their definitions.

It would therefore be advantageous to provide a solution that would overcome the deficiencies of the prior art by enhancing a user's exposure to novel units of information that the user desires to retain over the long term while minimizing the amounts of unfamiliar units of information in each content accessed by the user.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some aspects may be used herein to refer to a single aspect or multiple aspects of the disclosure.

The disclosure relates in various embodiments to a system for facilitating learning of unfamiliar texts appearing in content provided over a network. The system includes a processor communicatively connected to at least a user node and at least a source of content; a first storage unit coupled to the processor, the first storage unit comprising at least a reference to the content and at least a unit of information respective of the content, the at least a reference further comprising a vector of components, wherein each component of the vector of components comprises a value for a frequency of occurrence of the reference respective of the at least a unit of information; a second storage unit coupled to the processor, the second storage unit further comprising user information; and a memory communicatively connected to the processor, the memory containing instructions that, when executed by the processor, configure the system to: parse each content that has not yet been handled; tokenize each parsed content into at least a unit of information; provide the first storage unit with the at least a unit of information; provide the second storage unit with at least a value for a user's familiarity with the at least a unit of information; provide the second storage unit with at least a value for a user's desire to be exposed to the at least a unit of information; determine a suitability rank for the content to at least a user based on at least a value in the first storage unit and respective of the user information of the at least a user in the second storage unit; and recommend one or more content items respective of the suitability rank for each content.

The disclosure further relates in various embodiments to a method for facilitating learning of unfamiliar texts appearing in content provided over a network. The method includes parsing each content that has not yet been handled; tokenizing each parsed content into at least a unit of information; providing a first storage unit with the at least a unit of information; providing a second storage unit with at least a value for a user's familiarity with the at least a unit of information; providing the second storage unit with at least a value for a user's desire to be exposed to the at least a unit of information; determining a suitability rank for the content to at least a user based on at least a value in the first storage unit and respective of the user information of the at least a user in the second storage unit; and recommending one or more content items respective of the suitability rank of each content.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a system for providing learning assistance units according to an embodiment;

FIG. 2 is a flowchart illustrating updating of a content storage unit according to an embodiment;

FIG. 3 is a flowchart illustrating updating a user storage unit according to an embodiment;

FIG. 4 is a flowchart illustrating determination of a suitability rank of content based on a user's needs according to an embodiment; and

FIG. 5 is a binary matrix illustrating a content storage unit according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for facilitating learning of unfamiliar text that appears in content such as web-pages. Such facilitation generally occurs in one of two fashions: one with respect to the content itself and the other with respect to the user of content. Accordingly, a references storage unit is updated with references to content. For each piece of content, a frequency of at least a word or a sequence of words within the content is associated with such references to the content. With respect to the user, the frequency with which a user looked up a meaning of a word or sequence of words and the number of times the user is exposed to such a word or sequence of words are determined. The user may be continuously supplied with selected content to enhance his or her command of a particular subject respective of a word or a sequence of words.

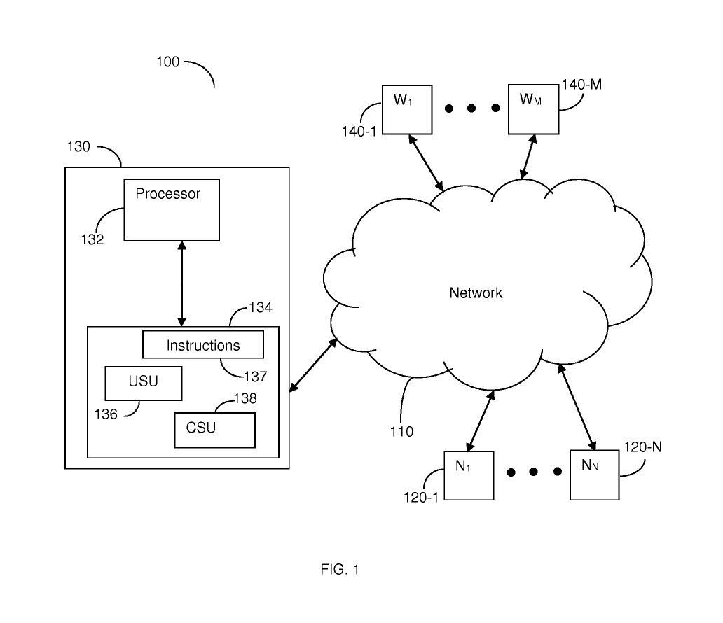

FIG. 1 shows an exemplary and non-limiting block diagram of a system 100 utilized to describe the various embodiments of providing learning assistance units. A network 110 is communicatively connected to several components. The network 110 can be a local area network (LAN), a wide area network (WAN), a metro area network (MAN), the worldwide web (WWW), the Internet, implemented as wired and/or wireless networks, and any combinations thereof.

In one embodiment, the system 100 may include one or more user nodes 120, i.e., user nodes 120-1 through 120-N, that are communicatively connected to the network 110. The one or more user nodes 120-1 through 120-N may be, but are not limited to, any of: a personal computer (PC), a notebook computer, a cellular phone, a smartphone, a tablet device, a laptop, a wearable computing device, and the like. A plurality of content resources 140, such as web servers 140-1 through 140-M, that provide content are also communicatively coupled to the network 110. Content may be provided, e.g., upon request. The provided content may be, for example, web pages, digital books (eBook), digital documents, or any type of content including textual information. Transcript shown in a view content.

In this embodiment, a learning assistance unit (LAU) 130 is communicatively connected to the network 110. In an exemplary implementation, the LAU 130 includes a processor 132 coupled to a memory 134. The memory 134 includes a content storage unit (CSU) 138 containing one or more references to content that may be accessible from any of the one or more web servers 140-1 through 140-M. The memory 134 contains instructions 137 that, when executed by the processor 132, configure the LAU 130 to check continuously, or at least periodically, for new content.

Content that the LAU checks for, may include, but is not limited to, articles from print and electronic sources, web pages, e-books, physical books, multimedia content (e.g., video clips, audio clips, images, animations, interactive content, etc.), movies, songs, and so on. In an embodiment, if content is not available to the user, the user may be directed to a web page or other source of content wherein he or she may request access to such content.

New content is content which has not been previously handled. In various embodiments, content which has not yet been handled may be identified as such. Content may be identified as not yet handled if, e.g., the content has not already been assigned a suitability ranking. A suitability ranking is generally a value that represents the suitability of the content for a particular user respective of user information. As a non-limiting example, suitability rankings may be based on a scale from 1 to 10, with 1 representing the lowest possible suitability and 10 representing maximum suitability. In a further embodiment, when content changes or is otherwise updated, that content may be identified as not yet handled regardless of whether the content has already been assigned a suitability ranking.

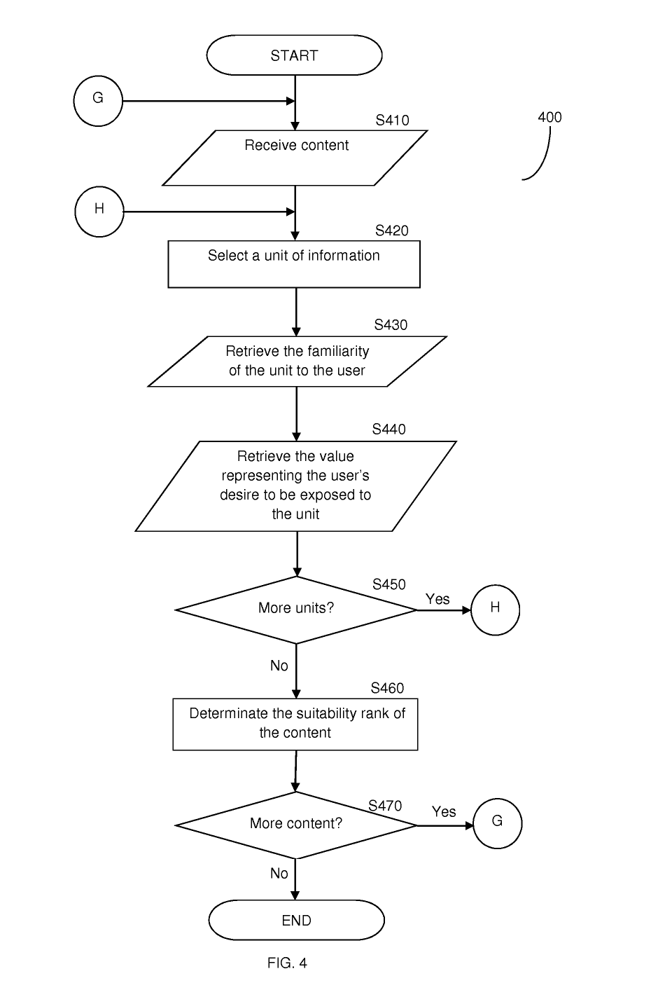

Suitability rankings may be used to determine which content to provide to a user by, but is not limited to, only providing a user with content that has a suitability ranking above a predefined threshold, only providing a user with a predetermined number of content items that have the highest suitability rankings among a set of content items, combinations thereof, and so on. Determination of suitability rankings is discussed further herein below with respect to FIG. 4.

As a non-limiting example, a user may be provided with 5 content items per browsing session, wherein the 5 content items provided to the user are selected from a group containing 100 content items. The 5 provided content items may be determined based on the higher suitability rankings of those 5 items when compared to the remaining 95 content items in the group. It should be noted that the number of content items provided in this example is not limiting and that various embodiments may utilize different numbers of provided content items or provide content based on other criteria (e.g., ten new pieces of content per hour, etc.) without departing from the scope of the disclosed embodiments.

The CSU 138 is updated with a reference respective of the new content or the updated content. Such content is parsed and tokenized into units of information by the LAU 130. The CSU 138 is then updated with a vector that represents a frequency of occurrences of each unit of information within the content. The update of the CSU 138 may be user independent, i.e., regardless of a particular user's information. For each user, a plurality of values is stored in a user storage unit (USU) 136, where the USU 136 is coupled to the processor 132. In one embodiment, the USU 136 may be included in the memory 134.

In this embodiment, the LAU 130 is configured to determine a value that represents a user's desire to be exposed to each unit of information and a value that represents the user's familiarity with each unit of information. The values may be determined and stored in the USU 136 on a continuous basis, or at least periodically, by the LAU 130. Respective of the values stored in the USU 136, the LAU 130 is configured to determine the number of times the user has been exposed to each unit of information. Further, the LAU 130 is configured to determine the frequency with which the user looked up a meaning of each unit of information. The LAU 130 is configured to rank a value that represents a suitability of the content to a user respective of each one of the references of the respective content stored in the CSU 138 and for every user respective of the user's plurality of values that are stored in the USU 136.

In various embodiments, respective of the suitability rankings, one or more items of content may be selected to be recommended to the user. In an embodiment, the item of content with the highest suitability ranking is recommended to the user. In another embodiment, multiple items of content which have the highest suitability ranking respective of other content items may be recommended.

As a non-limiting example, the LAU 130 is further configured to determine that there is new or updated content. The LAU 130, in an embodiment is configured to parse and tokenize such content into units of information. The LAU 130 is further configured to provide the CSU 138 with values representing the frequency of occurrence of each unit of information within the content.

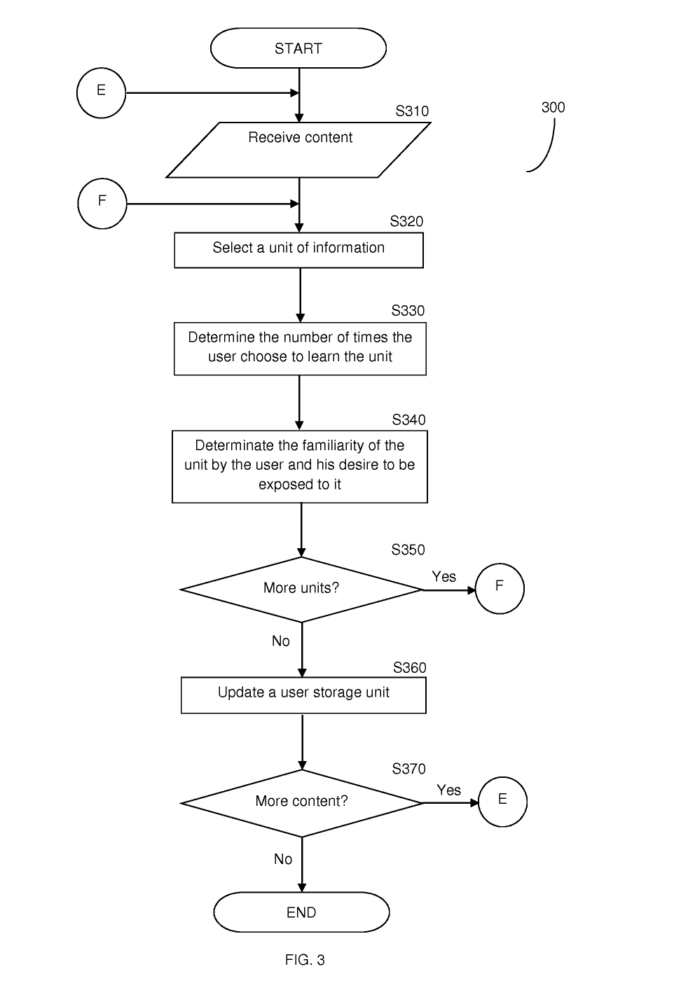

In this example, based on data related to the user's past exposure to each unit of information, the LAU 130 determines the user's familiarity with and desire to be exposed to each unit of information. Data related to a user's past exposure may be, but is not limited to, the number of times the user has been exposed to each unit of information, the number of times the user has looked up the unit of information, and so on. Determination of familiarity and desire values is described further herein below with respect to FIG. 3.

Based on the user's familiarity and desire values for units of information contained in the content, a suitability ranking may be determined for the content. Determination of suitability rankings is described further herein below with respect to FIG. 4. This suitability ranking is stored respective of the content in the CSU 138. Further, based on the relative suitability ranking of the content related to other content, one or more of such content is recommended to the user. In this example, an article featuring content that is suitable for the user is assigned the highest suitability ranking of all new content. Consequently, such article is recommended to the user.

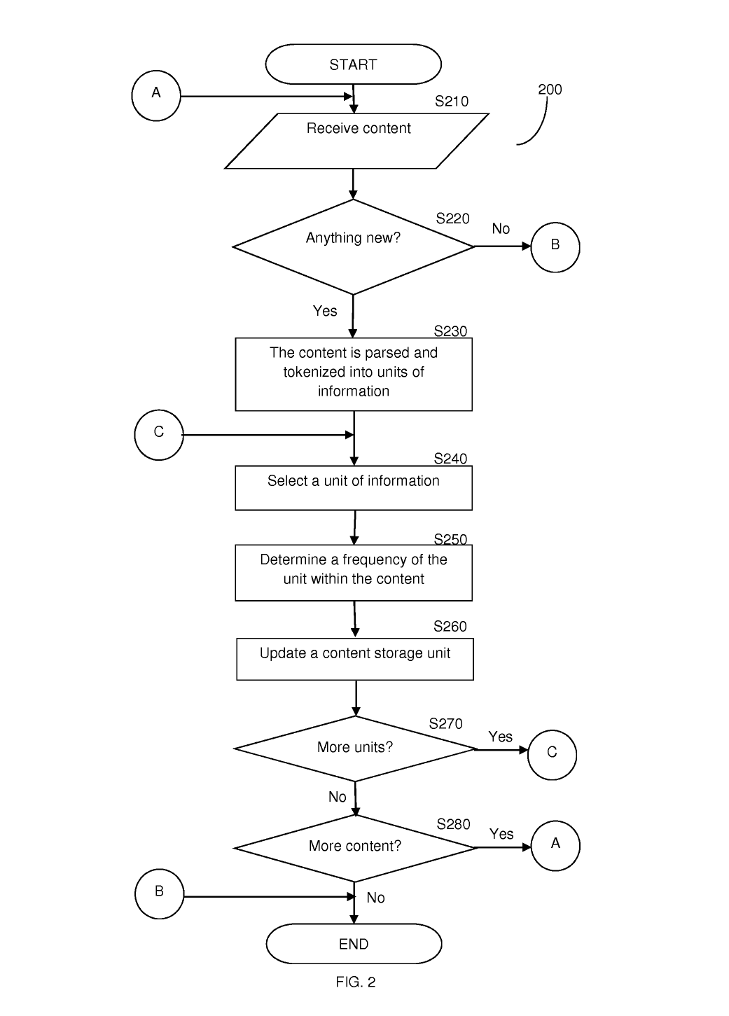

FIG. 2 shows an exemplary and non-limiting flowchart 200 illustrating updating of a content storage unit (CSU) (e.g., content storage unit 138) according to an embodiment. In S210, content is accessed. In an embodiment, the content may be content that is accessible, e.g., from one or more web servers 140-1 through 140-M. In S220, it is checked whether the accessed content is new content and, if so, execution continues with S230; otherwise, execution terminates.

New content is content which has not been previously handled. In various embodiments, content which has not yet been handled may be identified as such. Content may be identified as not yet handled if, e.g., the content has not already been assigned a suitability ranking. A suitability ranking is generally a value that represents the suitability of the content for a particular user respective of user information. In an embodiment, when content changes or being otherwise updated, that content may be identified as not yet handled regardless of whether the content has already been assigned a suitability ranking. New content is discussed further herein above with respect to FIG. 1.

In S230, the accessed content is parsed and tokenized into at least a unit of information. A unit of information may include, but is not limited to, a word, a sequence of words, a name, a definition, a grammar pointer, combinations thereof, etc. In an embodiment, parsing and tokenizing may be performed using predetermined instructions. As a non-limiting example, parsing and tokenizing may be performed according to instructions requiring that each unit of information represent one of the words in the accessed content.

In S240, one unit of information is selected. In various embodiments, selection may occur with respect to the order of units of information within accessed content. As a non-limiting example, if the accessed content includes the sentence “the dog barked,” the word “the” would be selected during the first iteration of the steps of flowchart 200. The words “dog” and “bark” would be the selected units of information in the second and third iterations, respectively.

In S250, the frequency of occurrence of the selected unit of information within the content is determined. The frequency of occurrence is typically the number of times the user has read the selected unit of information within the content. As a non-limiting example, if the accessed content includes four appearances of the word “cheese,” then the frequency of occurrence may be determined to be four.

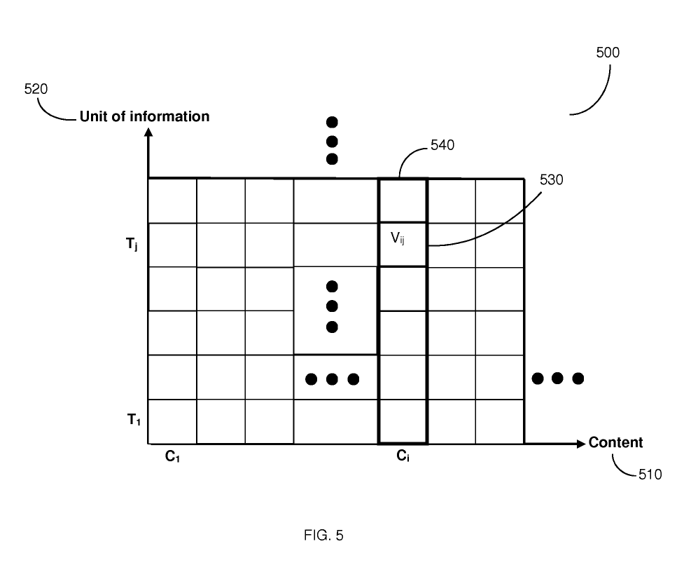

In S260, the CSU (e.g., CSU 138) is updated with the unit of information respective of the frequency of occurrence value of the unit of information within the content as discussed in greater detail herein below with respect to FIG. 5. In S270, it is checked whether there are additional units of information in the content that were not yet handled and, if so, execution continues with S240; otherwise, execution continues with S280. In S280, it is checked whether there is additional content to be gathered and, if so, execution continues with S210; otherwise, execution terminates.

As a non-limiting example, content containing the sentence “there's a hole in the bottom of the sea” is accessed. It is determined that the content does not yet have a suitability ranking and, thus, that the content is new. In this example, all accessed content is parsed and tokenized into units of information representing the individual words in the content. Also in this example, each unit of information is selected in order of appearance within the accessed content. Thus, “there's” is selected before “a,” “a” is selected before “hole,” and so on until “sea” is selected. The frequency of each unit of information is determined. The frequency of all units of information except for “the” is determined to be one. The frequency of the unit of information related to “the” is determined to be two. These frequency values are updated for each respective unit of information in a CSU.

FIG. 3 shows an exemplary and non-limiting flowchart 300 describing the operation of updating a user storage unit (USU) (e.g., USU 136) according to an embodiment. In S310, content is accessed. In an embodiment, such content may be accessible from one or more web servers 140-1 through 140-M. In S320, a unit of information is selected. In various embodiments, selection may occur with respect to the order of units of information within accessed content. Selection of units of information is described further herein above with respect to FIG. 2.

In S330, the number of times the user chose to look up the definition of the unit of information Tᵢ as well as the number of times the user has been exposed to the unit of information are determined. The number of times the user chose to look up the definition of the unit of information Tᵢ is represented by nᵢ^{L}. The number of times the user has been exposed to the unit of information Tᵢ is represented by nᵢ^{X}. In S340, the familiarity ωᵢ of the unit of information Tᵢ is determined. In an embodiment, such a determination may be made using Equation 1, shown below:

$${ω}_{i} = \{ \begin{matrix}0 & if {n}_{i}^{X} = 0 \\ \frac{{n}_{i}^{X} - {n}_{i}^{L}}{{n}_{i}^{X}} & otherwise\end{matrix} \qquad Equation 1$$

In an embodiment, the user's desire to be exposed to a unit of information may be determined in addition to or in place of the user's familiarity. The user's desire to be exposed to a unit of information Tᵢ may be represented by hᵢ, where hᵢ ranges between 0 (representing no desire to be exposed) and 1 (representing maximum desire). In one embodiment, the value representing the user's desire hᵢ to be exposed to a unit of information may be determined by using Equation 2, shown below:

$${h}_{i} = \{ \begin{matrix}0 & if {n}_{i}^{X} = 0 \\ \frac{{n}_{i}^{L}}{{n}_{i}^{X}} & otherwise\end{matrix} \qquad Equation 2$$

In S350, it is checked whether there are additional units of information in the content not yet checked and, if so, execution continues with S320; otherwise, execution continues with S360. In S360, the USU 136 is updated with the user's familiarity with the unit of information and/or the user's desire hᵢ to be exposed to the unit of information. In S370, it is checked whether additional content is to be gathered and, if so, execution continues with S310; otherwise, execution terminates.

As a non-limiting example, content containing the Greek word “thelo” is accessed. The unit of information respective of the word “thelo” is selected. The number of times the user chose to look up the word “thelo” and the number of times the user has been exposed to the word “thelo” are determined. In this example, the user has looked up the word “thelo” four times, and has been exposed to the word “thelo” five times. The user's familiarity with the word “thelo” is determined to be ⅕, while the user's desire to be exposed to the word “thelo” is determined to be ⅘. These values represent relatively low familiarity with and a high desire to be exposed to the word “thelo,” respectively. The USU is updated with the familiarity and desire values.

FIG. 4 depicts an exemplary and non-limiting flowchart 400 illustrating determination of a suitability rank of at least one content item for a user according to an embodiment. Suitable content may be, but is not limited to, content with a higher number of desired units of information within the content than in other content, and/or higher number of familiar units of information when compared to other content.

A unit of information may be desired if, e.g., the user's desire to be exposed to the unit of information is above a certain threshold. As a non-limiting example, if the threshold for desirability is ½, then a unit of information with a user's desire value hᵢ of ⅘ will be identified as a desired unit of information. Determination of a user's desire to be exposed to a unit of information is described further herein above with respect to FIG. 3.

A unit of information may be identified as familiar if, e.g., the familiarity of a unit of information is above a certain threshold. As a non-limiting example, if the familiarity threshold is ⅗, then a unit of information with a familiarity value wᵢ of ⅘ will be identified as a familiar unit of information. Determination of a user's familiarity with a unit of information is described further herein above with respect to FIG. 3.

In S410, content is retrieved. In S420, a unit of information contained in the content is selected. In various embodiments, selection may occur with respect to the order of units of information within accessed content. Selection of units of information is described further herein above with respect to FIG. 2. In S430, a value that represents the user's familiarity wᵢ with the unit of information is retrieved. In S440, the value that represents the user's desire hᵢ to be exposed to the unit of information is retrieved.

In S450, it is checked whether there are additional units of information in the content and, if so, execution continues with S420; otherwise, execution continues with S460. In S460, the suitability rank of the content respective of at least the user's familiarity wᵢ with each of the units of information contained in the content and the user's desire hᵢ to be exposed to each of the units of information contained in the content is determined. In an embodiment, such a determination may be made using Equation 3, shown below:

$$S = \frac{{\sum }_{i} {h}_{i}}{{\sum }_{i} ( 1 - {ω}_{i} )} \qquad Equation 3$$

In various embodiments, the determined suitability rank may be utilized to provide a recommendation of a content item to a user. The recommended content item is typically content which represents the highest suitability rank(s) compared to other content items. In S470, it is checked whether additional content will be gathered and, if so, execution continues with S410; otherwise, execution terminates.

FIG. 5 is an exemplary and non-limiting diagram illustrating the arrangement of data in the content storage unit (CSU) 500 according to an embodiment. The X axis 510 of CSU 500 represents references to content accessible on one or more web servers (e.g., web servers 140). That is, each item on the X axis 510 represents a different content item.

The Y axis 520 of CSU 500 represents references to units of information respective of the content. That is, each item on the Y axis 520 represents a different unit of information. Therefore, for each content item Cᵢ, there is a list of corresponding units of information. Moreover, the value Vᵢⱼ 530 represents the frequency of the unit of information within the content. For example, if the unit of information Tᵢ does not appear in the content Cᵢ then the value of Vᵢⱼ 530 is ‘0.’ If the unit of information Tᵢ appears 10 times, then the value of Vᵢⱼ 530 may be ‘10.’ It should be further understood that the vector 540 comprising a plurality of frequency values corresponding to a single content Cⱼ, represents the content Cⱼ for all purposes of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A system for facilitating learning of unfamiliar texts appearing in content provided over a network, comprising:
a processor communicatively connected to at least a user node and at least a source of content;
a first storage unit coupled to the processor, the first storage unit comprising at least a reference to the content and at least a unit of information respective of the content, the at least a reference further comprising a vector of components, wherein each component of the vector of components comprises a value for a frequency of occurrence of the reference respective of the at least a unit of information;
a second storage unit coupled to the processor, the second storage unit further comprising user information; and
a memory communicatively connected to the processor, the memory containing instructions that, when executed by the processor, configure the system to:
parse each content that has not yet been handled;
tokenize each parsed content into at least a unit of information;
provide the first storage unit with the at least a unit of information;
provide the second storage unit with at least a value for a user's familiarity with the at least a unit of information;
provide the second storage unit with at least a value for a user's desire to be exposed to the at least a unit of information;
determine a suitability rank for the content to at least a user based on at least a value in the first storage unit and respective of the user information of the at least a user in the second storage unit; and
recommend one or more content items respective of the suitability rank for each content.

2. The system of claim 1, wherein the at least a source of content is a web server.

3. The system of claim 1, further configured to:
determine whether content has been changed; and
upon determining that content has been changed, identify the content as not yet handled.

4. The system of claim 1, wherein the user node is at least one of: a personal computer, a notebook computer, a cellular phone, a smartphone, a laptop, a wearable computing device and a tablet device.

5. The system of claim 1, wherein the content which has not yet been assigned a suitability rank is at least one of: a word, a name, a definition, a relationship, a grammar tip, a sequence thereof, a combination thereof, and a portion thereof.

6. The system of claim 1, further configured to:
determine the number of times the user is exposed to at least a unit of information.

7. The system of claim 6, further configured to:
determine a frequency with which the user looked up a meaning of the at least a unit of information.

8. A method for facilitating learning of unfamiliar texts appearing in content provided over a network, comprising:
parsing each content that has not yet been handled;
tokenizing each parsed content into at least a unit of information;
providing a first storage unit with the at least a unit of information;
providing a second storage unit with at least a value for a user's familiarity with the at least a unit of information;
providing the second storage unit with at least a value for a user's desire to be exposed to the at least a unit of information;
determining a suitability rank for the content to at least a user based on at least a value in the first storage unit and respective of the user information of the at least a user in the second storage unit; and
recommending one or more content items respective of the suitability rank of each content.

9. The method of claim 8, wherein the at least a source of content is a web server.

10. The method of claim 8, further comprising:
determining whether content has been changed; and
upon determining that content has been changed, identifying the content as not yet handled.

11. The method of claim 8, wherein the user node is at least one of: a personal computer, a notebook computer, a cellular phone, a smartphone, a laptop, a wearable computing device and a tablet device.

12. The method of claim 8, wherein the content which has not yet been assigned a suitability rank is at least one of: a word, a name, a definition, a relationship, a grammar tip, a sequence thereof, a combination thereof, and a portion thereof.

13. The method of claim 8, further comprising:
determining the number of times the user is exposed to at least a unit of information.

14. The method of claim 13, further configured to:
determine a frequency with which the user looked up a meaning of the at least a unit of information.
